(19) United States
(12) Patent Application Publication
(10) Pub. No.: US 2018/0066435 A1
(43) Pub. Date: Mar. 8, 2018

(54) EMBOSSED SLIP RESISTANT SHEET MATERIAL FOR ROOFING

(71) Applicant: ATLANTIC COATED PAPERS LTD., Whitby (CA)

(72) Inventors: David GRANOVSKY, Toronto (CA); Steve LOMBARDI, Cambridge (CA); Sylvain JUTRAS, Drummondville (CA)

(21) Appl. No.: 15/810,109

(22) Filed: Nov. 12, 2017

Related U.S. Application Data
(63) Continuation-in-part of application No. 14/529,116, filed on Oct. 30, 2014.

(51) Int. Cl. E04D 12/00; E04D 5/06; E04D 5/10; B32B 5/02

(52) U.S. Cl. CPC E04D 12/002; E04D 5/06; E04D 5/10; D10B 2321/021; B32B 2274/00; D10B 2331/04; D10B 2401/063; B32B 5/024

(57) ABSTRACT

The present document describes a slip resistant sheet material for roofing having a thickness and being adapted for a worker to walk thereon in his footwear. The slip resistant sheet material comprises a base layer and a thermoplastic layer affixed to the base layer. The thermoplastic layer comprises embossments and corresponding depressions transverse to the thickness of the slip resistance material whereby, when the worker walks on the slip resistant sheet material, there exists friction between the footwear and the embossments in the thermoplastic layer thereby providing slip resistance.

### CROSS-REFERENCE TO RELATED APPLICATION

This application is a continuation-in-part of U.S. patent application Ser. No. 14/529,116 filed Oct. 30, 2014, the specification of which is hereby incorporated herein by reference in its entirety.

### BACKGROUND

### (a) Field

The subject matter disclosed generally relates to slip resistant sheet materials for roofing and to methods for manufacturing slip resistant sheet materials for roofing. More particularly, the subject matter disclosed relates to a weather-resistive barrier for a roofing structure, and especially to a reinforced roof underlayment having a slip resistant feature.

### (b) Related Prior Art

Roofing structures for buildings typically include an underlayment positioned between a roof support deck and an overlayment. The overlayment, such as asphalt shingles, tiles, wooden shakes, slate tiles metal roofing, or the like is intended to provide protection from external weather conditions like wind, rainwater, and snowmelt. In order to further protect against moisture and other elements which may pass under the overlayment, the underlayment is installed over the roof deck and under the underlayment to provide an added waterproof barrier. The additional moisture protection provided by the underlayment is particularly necessary with tile roofs, where gaps often exist between the tiles where moisture can pass through. The underlayment also serves the function of providing a seal around roofing fasteners used to affix the tiles to the roof support deck.

Typically, underlayment may include a polymeric material that is affixed and/or coated to a base sheet for providing a barrier to weather conditions. A limitation of such underlayment is that these polymeric materials can be very slippery in both wet and dry conditions. Installation of the underlayment and the subsequent roofing material can therefore be problematic as workers may need to walk across or work upon the polymeric material coated or affixed to the base sheet. This decreases the commercial attractiveness of such underlayment for high pitch roof applications or in climates characterized by wet or humid conditions.

Accordingly, there is a need for a roofing underlayment having an improved resistance to deterioration from exposure to external elements which prevents a person from slipping while moving about on the roofing underlayment and for an improved method of manufacturing the same.

### SUMMARY

According to an embodiment, there is provided a slip resistant sheet material for roofing having an upper side, the slip resistant sheet material comprising:
a closed-weave woven base layer having a top surface facing towards the upper side; and
a thermoplastic layer affixed to the top surface, wherein the thermoplastic layer comprises, on the upper side, slip-resistant embossments and further wherein the slip-resistant embossments are present in the thermoplastic layer and absent from the closed-weave woven base layer.

According to the above embodiment, there is no embossments or embossing in the closed-weave woven base; i.e., the closed-weave woven base is free from embossments or embossing.

According an embodiment, the slip-resistant embossments are only present in the thermoplastic layer.

According to an aspect, the thermoplastic layer has a thickness and wherein the embossments are defined transversely to the thickness of the slip resistant sheet material.

According to an aspect, the embossments have a height smaller than the thickness of the thermoplastic layer.

According to an aspect, the embossments are spread, scattered, dispersed or punctuated over the upper side.

According to an aspect, the slip resistant sheet material further comprises inter-embossment depressions, wherein the inter-embossment depressions define paths for rain falling on the upper side to flow downward between the embossments when the slip resistant sheet material is installed on a sloped structure.

According to an aspect, the slip resistant sheet material is adapted for a worker to walk thereon in his footwear and whereby, when the worker walks or stands on the slip resistant sheet material, there exists friction between the footwear and the embossments on the thermoplastic layer thereby providing slip resistance.

According to an aspect, the closed-weave woven base layer further comprises a bottom surface opposite the top surface and the slip resistant sheet material further comprises an additional thermoplastic layer affixed to the bottom surface.

According to an aspect, at least one of the thermoplastic layer and the additional thermoplastic layer is directly affixed to one of the top surface and the bottom surface without use of an adhesive or another intermediate layer.

According to an aspect, at least one of the thermoplastic layer and the additional thermoplastic layer is vapor impermeable.

According to an aspect, at least one the thermoplastic layer and the additional thermoplastic layer is a film-forming polymer.

According to an aspect, at least one the thermoplastic layer and the additional thermoplastic layer comprises at least one of: polyethylene and polypropylene.

According to an aspect, the closed-weave woven comprises cross-laminated polyethylene tape.

According to an embodiment, there is provided a method of manufacturing a slip resistant sheet material for roofing having an upper side. The method comprises the steps of:
providing a closed-weave woven base layer having a top surface;
affixing a thermoplastic layer to the top surface of the closed-weave woven base layer; and
embossing the thermoplastic layer with an embossed roller comprising a pattern of depressions, the embossing transferring the pattern depressions to the upper side of thermoplastic layer into a pattern of slip-resistant embossments, wherein the slip-resistant embossments are present on the thermoplastic layer and absent from the closed-weave woven base layer.

According to an aspect, the embossing step is performed before cooling down the thermoplastic layer.

According to an aspect, the embossing step comprises passing the slip resistant sheet material between two rollers, wherein one of the two rollers comprises the embossing roller.

According to an aspect, the closed-weave woven base layer further comprises a bottom surface opposite the top surface and the method further comprises affixing an additional thermoplastic layer to the bottom surface.

According to an aspect, at least one of the affixing the thermoplastic layer step and the affixing the additional thermoplastic layer step comprises directly affixing the respective one of the thermoplastic layer and the additional thermoplastic layer to the respective one of the top surface and to the bottom surface without use of an adhesive or another intermediate layer.

According to an aspect, at least one of the affixing the thermoplastic layer step and the affixing the additional thermoplastic layer step comprises respectively extruding a film-forming polymer thereby producing the thermoplastic layer and the additional thermoplastic layer.

According to an aspect, the extruding a film-forming polymer step comprises extruding at least one of: polyethylene and polypropylene.

The following terms are defined below.

The term “slip resistant sheet material” is intended to mean a sheet material provided with an additional means for increasing the slip resistance and thereby increasing safety of those walking on roofs, or on any surfaces, on which the slip resistance sheet material is installed before installation of an overlayment.

The terms “embossing”, “embossment”, “embossed” material and results from a process of embossing are intended to refer to the result of an impression produced by pressure or printing and the process of making that impression over a receiving material or surface.

The term “closed-weave woven” is intended to mean yarns or threads that are normally tightly interlaced at a right angle to form a fabric or a sheet material. The method in which these yarns or threads are interwoven affects the characteristics of the fabric or of the sheet material. The yarns or threads that are tightly interlaced may also be at an angle different than the right angle.

The term “thermoplastic layer” is intended to mean an elastic and flexible layer, made of a thermoplastic material, to be affixed to at least one of the top surface and bottom surface of a closed-weave woven. The “thermoplastic layer” may provide a weather-resistant barrier which prevents moisture and other external elements from passing through the slip resistant sheet material.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is an elevation view of a slip resistant sheet material for roofing in accordance with an embodiment;

FIG. 2 is an enlarged, fragmentary, cross-sectional view of the slip resistant sheet material for roofing of FIG. 1;

FIG. 2a is another enlarged, fragmentary, cross-sectional view of the slip resistant sheet material for roofing of FIG. 1;

FIG. 2b is yet another enlarged, fragmentary, cross-sectional schematic view of the slip resistant sheet material for roofing of FIG. 1;

FIG. 2c is an enlarged, fragmentary, cross-sectional schematic view of the slip resistant sheet material for roofing where only the base layer and the first thermoplastic layer are present;

FIG. 3 is an exploded, perspective view of the slip resistant sheet material for roofing of FIG. 1;

FIG. 4 is an elevation view of a slip resistant sheet material for roofing in accordance with another embodiment;

FIG. 5 illustrates a method for manufacturing a slip resistant sheet material for roofing in accordance with another embodiment;

FIG. 6 is a perspective view of slip resistant sheet materials for roofing being installed on an exemplary roof structure in accordance with another embodiment;

FIG. 7 is a perspective view showing the slip resistant sheet materials for roofing of FIG. 6 in a later stage of the installation process;

FIG. 8 illustrates a process for manufacturing a slip resistant sheet material for roofing in accordance with another embodiment;

FIG. 9 is an elevation view of a slip resistant sheet material for roofing in accordance with another embodiment;

FIG. 10 is an enlarged, fragmentary, cross-sectional view of the slip resistant sheet material for roofing of FIG. 9;

FIG. 11 is an exploded, perspective view of the slip resistant sheet material for roofing of FIG. 9;

FIG. 12 illustrates a method for manufacturing a slip resistant sheet material for roofing of FIG. 9;

FIG. 13 is a perspective view of the slip resistant sheet materials for roofing of FIG. 9 being installed on an exemplary roof structure in accordance with an embodiment;

FIG. 14 is a perspective view of the slip resistant sheet materials for roofing of FIG. 9 being installed on an alternative roof structure in accordance with an embodiment;

FIG. 15 is a perspective view showing the slip resistant sheet materials for roofing of FIG. 9 in a later stage of the installation process on the roof structure of FIG. 13;

FIG. 16 is a perspective view showing the slip resistant sheet materials for roofing of FIG. 9 in a later stage of the installation process on the roof structure of FIG. 14;

FIG. 17 illustrates a process for manufacturing a slip resistant sheet material for roofing or FIG. 9 in accordance with an embodiment;

FIG. 18 is an elevation view of an embodiment of a textured roller for manufacturing an embodiment of the slip resistant sheet material for roofing in accordance with another embodiment; and

FIG. 19 is an elevation view of the embodiments of the slip resistant sheet material for roofing manufactured using the roller of FIG. 18.

It will be noted that throughout the appended drawings, like features are identified by like reference numerals.

### DETAILED DESCRIPTION

There is disclosed herein various embodiments of a slip resistant sheet material for roofing and of a method for manufacturing a slip resistant sheet material for roofing.

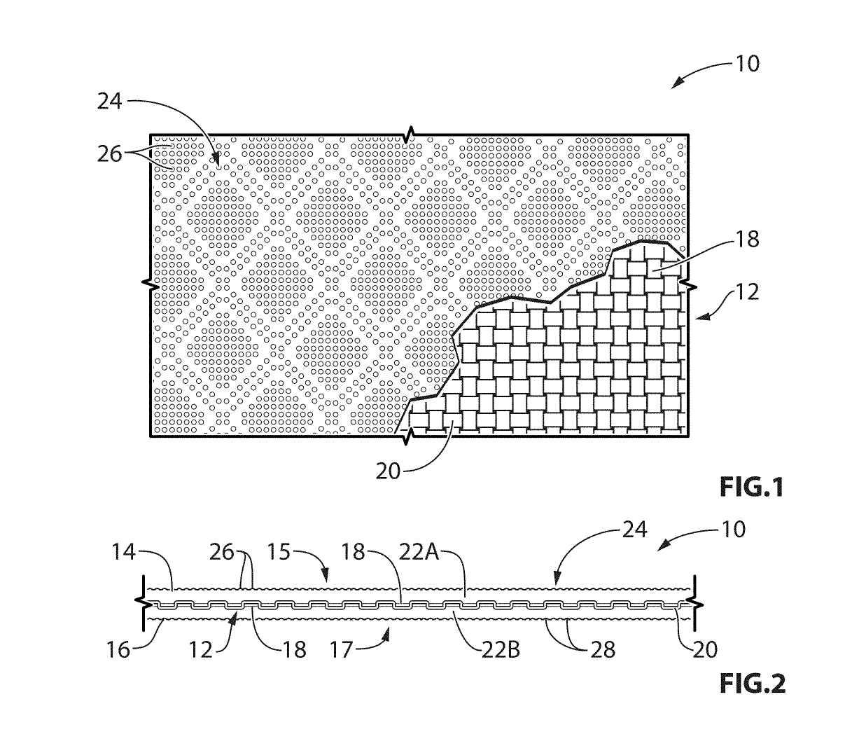

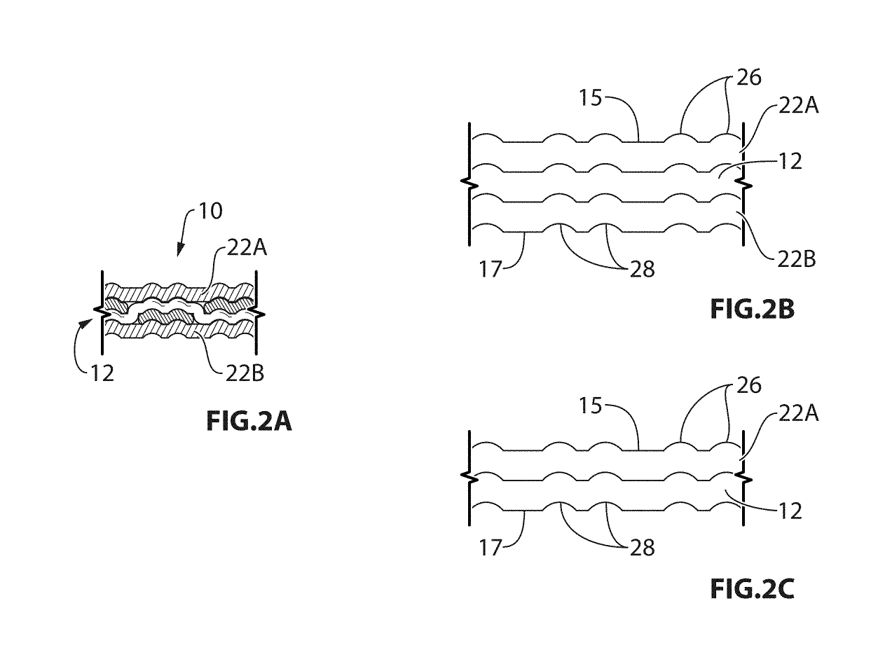

Referring now to the drawings, and more particularly to FIG. 1, there is shown an elevation view of a slip resistant sheet material 10 for roofing in accordance with an embodiment. The slip resistant sheet material 10 for roofing has an upper side 15 and a lower side 17. The slip resistant sheet material 10 for roofing further includes a base layer 12 which defines a top surface 14 and a bottom surface 16 (FIG. 2). The top surface 14 faces in a same direction as the upper side 15.

According to an embodiment, base layer 12 comprises a closed-weave woven which is referred herein to as a closed-weave woven base layer 12. According to another embodiment, the base layer 12 comprises a non-woven fibrous material such as a spunbond polyester substrate.

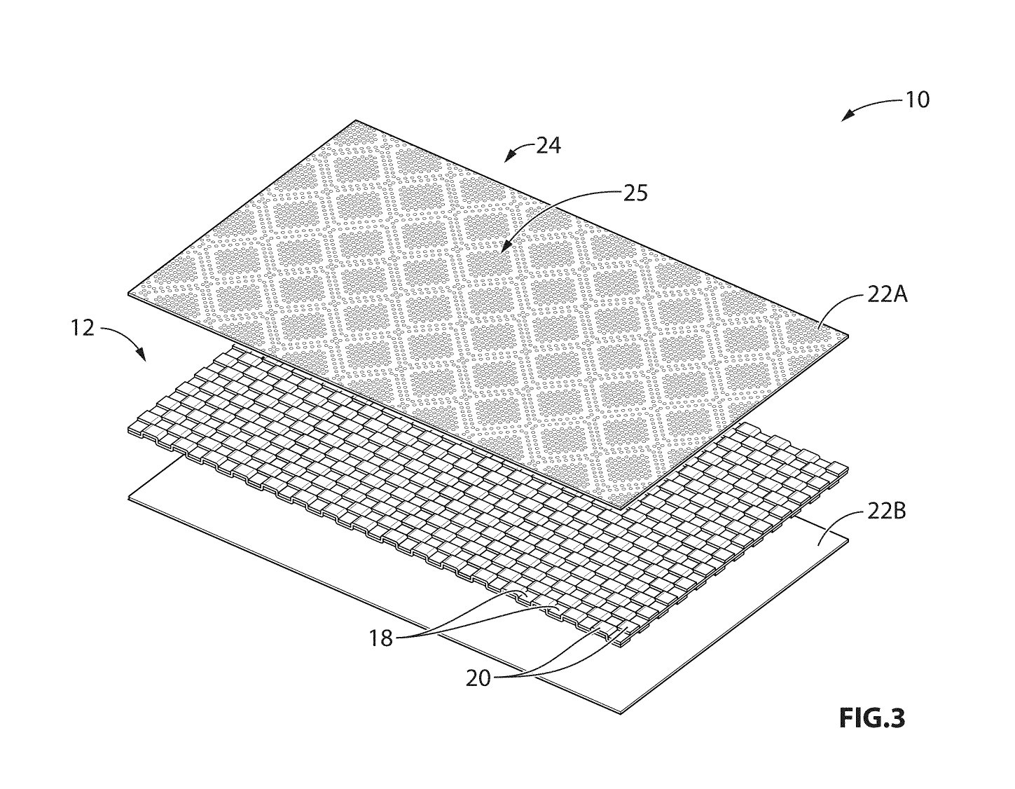

According to an embodiment, the closed-weave woven base layer 12 includes yarns of a first direction 18 and yarns of a second direction 20 that are interspersed with the yarns of the first direction 18. As better shown in FIG. 2, which is a, cross-sectional view of the slip resistant sheet material 10 for roofing of FIG. 1, and in FIG. 3, which is an exploded, perspective view of the slip resistant sheet material 10 for roofing of FIG. 1, the slip resistant sheet material 10 for roofing further includes thermoplastic first and second layers 22A, 22B respectively affixed to the top surface side 14 and the bottom surface 16 of the closed-weave woven base layer 12 for providing a weather-resistant barrier. Still referring to FIGS. 2 and 3, there is shown that a first thermoplastic layer 22A is affixed to the top surface 14 of the closed-weave woven and a second thermoplastic layer 22B (optional) is affixed to the bottom surface 16 of the closed-weave woven base layer 12.

As shown in FIGS. 1-3, the closed-weave woven base layer 12 and the first and second thermoplastic layers 22A, 22B are embossed to form an embossed pattern 24. The embossed pattern 24 has a plurality of projections 26 that outwardly extends from the first thermoplastic layer 22A and a plurality of corresponding depressions 28 that inwardly extends from the second thermoplastic layer 22B for providing slip resistance. The projections 26 of the embossed pattern 24 along with the first thermoplastic layer 22A provide an anti-skid surface/enhanced friction surface/slip resistant surface.

The embossed pattern 24 increases the slip resistance and thereby increasing safety of those walking on roofs on which the slip resistant sheet material 10 is installed before installation of an overlayment 36 (FIG. 7).

According to FIGS. 1-3, there is shown that the plurality of projections 26 and the plurality of corresponding depressions 28 are regularly spaced within the embossed pattern 24 such as to define a specific mosaic or pattern, such as pattern 25. However, it is to be noted that the plurality of projections 26 and the plurality of corresponding depressions 28 may be irregularly spaced within the embossed pattern 24 as long as it increases the slip resistance and thereby increases safety of those walking on roofs on which the slip resistant sheet material 10 is installed before installation of the overlayment 36.

The embossed pattern 24 includes a texture formed by a plurality of features that are raised and or sunken with respect to the closed-weave woven base layer 12 and the first and second thermoplastic layers 22A, 22B. For example, the texture can include a plurality of protrusions or projections 26 and a plurality of corresponding depressions 28 (i.e., cavities, voids) in the closed-weave woven base layer 12 and the first and second thermoplastic layers 22A, 22B. The texture of the embossed pattern 24 may be of varying heights or depths or can be substantially the same height or depth. Example of heights and depths of the texture include between about 0.01 mm to 10 mm. The texture can be disposed randomly or can be configured as a uniform or repeated pattern, such as pattern 25. Where the texture is disposed as an array of uniform or repeating configurations, examples may include straight lines, a cross-hatch pattern, a chevron pattern, a checked pattern, a company logo, dots, and the like. The texture can include raised and/or sunken features that are adjacent to each other or spaced apart from each other providing various densities. Examples include where the texture includes between 1 feature to 100 features per cm² of the slip resistant sheet material 10. Additionally, the features of the texture can have the same shape or can have varying shapes such as square, triangular, circular, ovular, obround, rectangular, random, or any other suitable shape configured to form the anti-skid surface.

In accordance with embodiments, the slip resistant sheet material 10 may include only one thermoplastic layer, a first and a second thermoplastic layers, or a plurality of different thermoplastic layers, some providing weather-resistant barrier, some other providing UV-resistant barrier, microbial properties, heat resistant properties and the like. It is to be noted that all the thermoplastic layers and the closed-weave woven base layer 12 need to be embossed to form the embossed pattern 24. This configuration will provide the safety of those walking on roofs.

In accordance with an embodiment, the thermoplastic layer or the plurality of thermoplastic layers 22A, 22B may include a film-forming polymer.

In accordance with an embodiment, the thermoplastic layer or the plurality of thermoplastic layers 22A, 22B comprise(s) polyethylene, polypropylene or a mixture of polyethylene and polypropylene.

In accordance with an embodiment, the yarns of the first direction 18 and the yarns of the second direction 20 are substantially flat, but can adopt any other cross-sectional configurations.

The thermoplastic layers 22A, 22B (first thermoplastic layer 22A and second thermoplastic layer 22B) are normally affixed to both the upper and the top surface 14 and the bottom surface 16 of the closed-weave woven base layer 12, as shown in the slip resistant sheet material 10 for roofing of FIGS. 2 and 3.

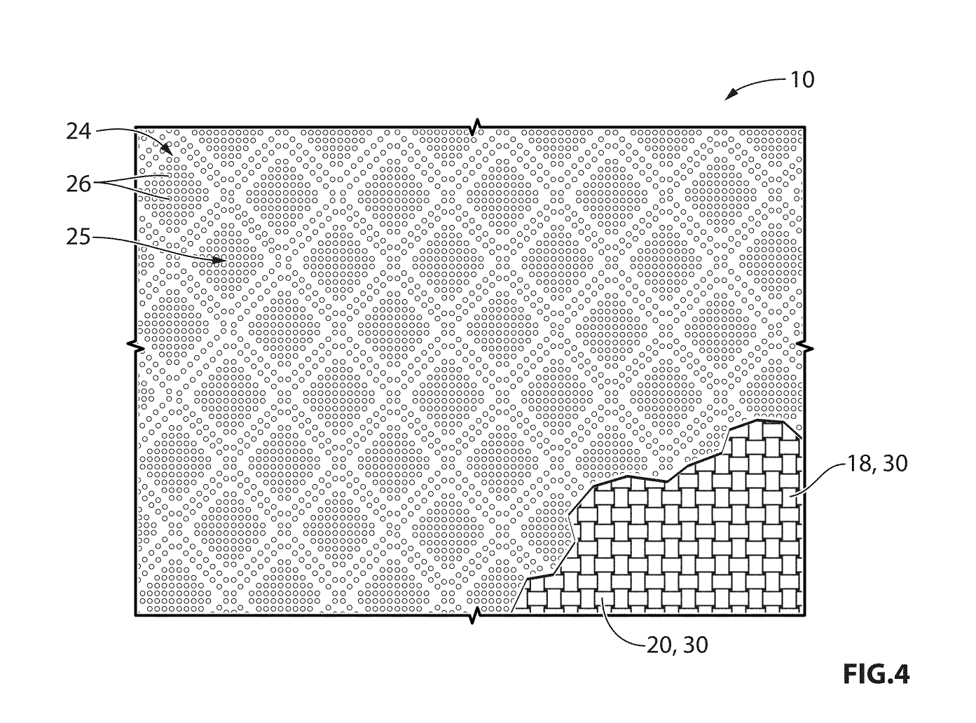

Now referring to FIG. 4 and in accordance with another embodiment, the closed-weave woven base layer 12 may be formed of yarns of a first gauge 30 of material having a tensile strength sufficient to resist tearing when exposed to tensile loads from various directions. The yarns of the first gauge 30 are normally the yarns of the first direction 18 and the yarns of the second direction 20. More specifically, the slip resistant sheet material 10 for roofing includes the closed-weave woven base layer 12, which includes yarns of the first direction 18 and yarns of the second direction 20. The closed-weave woven base layer 12 may further includes yarns of a second gauge 32, interspersed within the closed-weave woven base layer 12 with the yarns of the first direction 18 (as shown in FIG. 4) and/or with the yarns of the second direction 20. The yarns of the second gauge 32 include a gauge that is greater than the first gauge. As better shown in FIG. 4, the yarns of the second gauge 32 are interspersed in the closed-weave woven base layer 12 at a given interval with the yarns of the first direction 18.

In accordance with an embodiment, the yarns of the second gauge 32 of the closed-weave woven base layer 12 are parallel to each other. In the closed-weave woven base layer 12, the spacing between the parallel yarns of the second gauge is substantially equal. The yarns of the second gauge 32 of the closed-weave woven base layer 12 may also be perpendicular to each other.

Still referring to FIG. 4, there is shown an elevation view of the closed-weave woven base layer 12 of the slip resistant sheet material 10 for roofing in accordance with an embodiment. In FIG. 4, a first group of yarns of the first gauge are in a first direction (yarns of the first direction 18), a second group of yarns of the first gauge are in a second direction (yarns of the second direction 20) perpendicular to the first direction and a third group of yarns of the second gauge 32 are in the direction parallel to the yarns of the first direction 18. Also, the yarns of the second gauge 32 may be interspersed at the given interval in at least one of the first and second directions for providing an additional slipping resistance in addition to the embossed pattern 24 for preventing a person from slipping while moving on the slip resistant sheet material 10 for roofing. It is to be noted that the given interval is a multiple of 18 yarns in an embodiment, as shown in FIG. 4 and referred to as X1. In other embodiments the multiple may be 6 yarns, 9 yarns, 12 yarns, 15 yarns, 36 yarns, 72 yarns, 90 yarns, or any given interval of yarns (not shown) such as to further prevent slipping from a worker. Thus, according to different embodiments, the given interval may be a multiple of any suitable number.

In accordance with an embodiment, the given interval may be a mix of at least two given intervals. For instance, for allowing a worker to walk on a roofing structure without sliding, the slip resistant sheet material 10 for roofing may include a first group of three yarns of the second gauge 32 interspersed at a given interval of 6 yarns of the yarns of the first direction 18 in the closed-weave woven base layer 12 and another yarn of the second gauge 32, distant from the first group of three yarns of the second gauge 32, at another given interval of 72 yarns of the yarns of the first direction 18.

According to another embodiment, the given interval is one of: a regular given interval and an irregular given interval. As another example, a first group of three yarns of the second gauge 32 may intersperse the closed-weave woven base layer 12 at a first quarter of the closed-weave woven base layer 12, a second group of three yarns of the second gauge 32 may intersperse the closed-weave woven base layer 12 at a first half of the closed-weave woven base layer 12 and a third group of three yarns of the second gauge 32 may intersperse the closed-weave woven base layer 12 at a second quarter of the closed-weave woven base layer 12.

It is also to be noted that the yarns of the first direction 18 and the yarns of the second direction 20 are tightly interwoven. The yarns of the first direction 18 and the yarns of the second direction 20 of the closed-weave woven base layer 12 may be formed of a thermoplastic polymer, such as polypropylene, polyethylene, polyester, nylon or other similar materials. However, it is to be noted that the yarns of the first direction 18 and the yarns of the second direction 20 of the closed-weave woven base layer 12 may be of any suitable material that has strength sufficient to resist tearing when exposed to tensile loads from various directions.

The yarns of the first direction 18 and the yarns of the second direction 20 are interwoven as shown in FIGS. 1-4, by way of example, to provide a closed-weave woven base layer 12 having an improved tensile strength not achievable with solid film of material. The orientation of the yarns of the first direction 18 and the yarns of the second direction 20 may also be selected to optimize their tensile strength.

The yarns of the first gauge 30 (i.e., the yarns of the first direction 18 and the yarns of the second direction 20) and the yarns of the second gauge 32 may comprise any cross-sectional shape and size, depending upon the desired tensile characteristics of the closed-weave woven base layer 12. For example, the yarns of the first gauge 30 may be interwoven fibers as shown in FIG. 2, may be cross-laminated polyethylene tape, or may include any other interwoven configuration. The size of the yarn of the first gauge 30 may be approximately between 800 Denier to 1,000 Denier. The size of the yarn of the second gauge 32 may be approximately between 1,000 Denier and 12,000 Denier. However, the size of the yarns of the first gauge 30 and the size of the yarns of the second gauge 32 may be of any suitable size allowing the formation of a tight closed-weave woven base layer 12.

Referring to FIGS. 2 and 3, the first and second thermoplastic layers 22A, 22B affixed to both the top surface 14 and the bottom surface 16 of the closed-weave woven base layer 12 provide a weather-resistant barrier which prevents moisture and other external elements from passing through the slip resistant sheet material 10 for roofing. An exemplary embodiment for the first and second thermoplastic layers 22A, 22B includes a layer of thermoplastic film which is extruded over each side of the closed-weave woven base layer 12, so that the closed-weave woven base layer 12 is sandwiched between the first and the second thermoplastic layers 22A, 22B.

The slip resistant sheet material 10 for roofing is shown as having a thermoplastic layer 22A or 22B positioned over each side of the closed-weave woven base layer 12. However, it is understood that certain applications may allow the closed-weave woven base layer 12 to have only one side coated with a thermoplastic layer. The thermoplastic layer(s) (such as first and second thermoplastic layers 22A, 22B) may include polyethylene, polypropylene, or other similar thermoplastic polymers.

The slip resistant sheet material 10 for roofing is formed by extruding layers of thermoplastic polymer over the closed-weave woven base layer 12. According to an embodiment, the first and the second thermoplastic layers 22A, 22B are directly affixed to the base layer without use of an adhesive or another intermediate layer.

According to another embodiment, the thermoplastic layers may be affixed to the closed-weave woven base layer 12 using an adhesive or any other manner of attachment.

The thermoplastic layers (i.e., such as first and second thermoplastic layers 22A, 22B) may be variably pigmented to allow the color of the thermoplastic layers to be selected based upon particular requirements. The thickness of the thermoplastic layers is selected such that the slip resistant sheet material 10 for roofing is flexible, whereby the flexible nature of the slip resistant sheet material 10 for roofing allows it to be formed into rolls and easily installed by simply unrolling the slip resistant sheet material 10 for roofing over a roof support structure or the like.

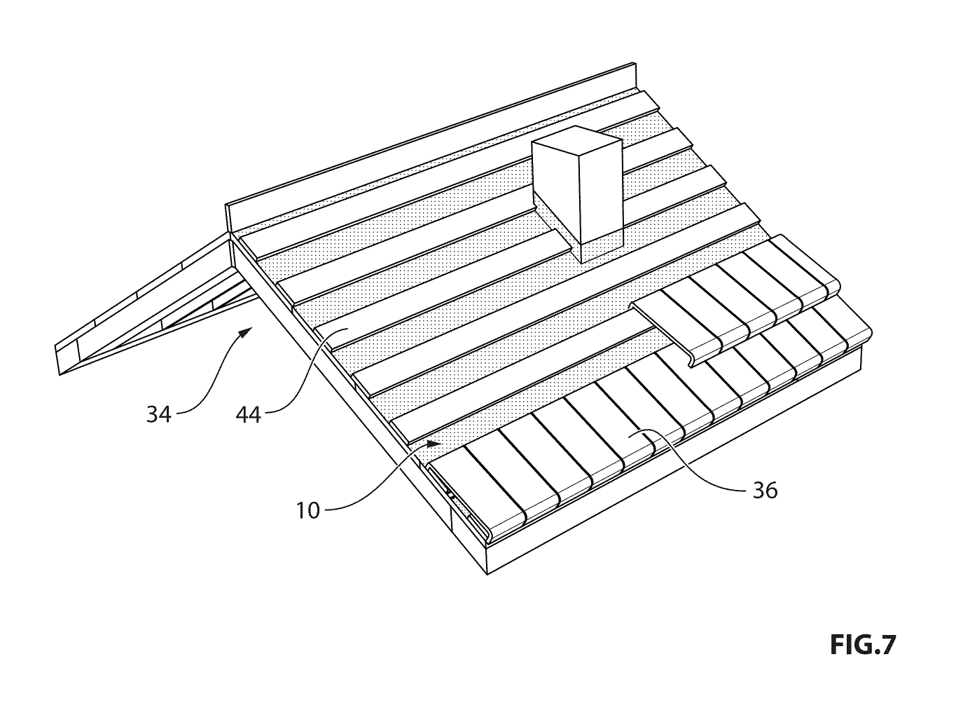

The slip resistant sheet material 10 for roofing may be installed between a roof support structure 34 (FIG. 6) and an overlayment 36 (FIG. 7) in order to provide a waterproof barrier for the roof structure. The slip resistant sheet material 10 for roofing may be mechanically fastened to the roof rafters 38 (FIG. 6) using nails or screws, but it is understood that the slip resistant sheet material 10 for roofing may be affixed to the roof rafters 38 using adhesives or other possible attachment methods.

The slip-resistant sheet material 10 for roofing may be formed from a plurality of thermoplastic layers having an improved resistance to deterioration from exposure to external elements, such as moisture and dirt, so that the slip resistant sheet material 10 for roofing has an improved durability and longevity. Moreover, employing closed-weave woven base layer 12 including yarns of a second gauge 32 in the slip resistant sheet material 10 for roofing provides an improved tensile strength capable of being walked upon without tearing when being installed on the roof. The closed-weave woven base layer 12 further provides improved strength to resist tearing when exposed to external forces, such as collected moisture, wind, and other external forces.

As shown, the improved resistance to deterioration and tearing provided by the slip resistant sheet material 10 for roofing improves the integrity and effectiveness of the weather-resistant barrier provided by the slip resistant sheet material 10 for roofing. By improving the longevity of the waterproof integrity of the slip resistant sheet material 10 for roofing to more closely match the integrity of the entire roof structure, the longevity of the integrity of the entire roof structure is improved.

According to an embodiment, and referring now to FIG. 6, there is shown a perspective view of the slip resistant sheet material 10 for roofing being installed on an exemplary roof structure. The slip resistant sheet material 10 for roofing is to be installed between a roof support structure 34 and an overlayment 36 in order to provide a waterproof barrier and a slip resistant material for the roof structure. As shown, the slip resistant sheet material 10 for roofing may be formed into rolls 40 which can be simply unrolled over the roof support structure 34 to allow for easy installation. In this exemplary roof structure, the sarking method is utilized where the slip resistant sheet material 10 for roofing is fastened to the top side of the roof rafters 38 and allowed to drape between the open rafter bays 42. The slip resistant sheet material 10 for roofing is preferably mechanically fastened to the roof rafters 38 using nails or screws, but it is understood that the slip resistant sheet material 10 for roofing may be affixed to the roof rafters 38 using another adhesives or other possible attachment methods.

Battens 44 are then fastened over the slip resistant sheet material 10 for roofing and into the top side of the roof rafters 38, where the overlayment 36 is then attached to the battens 44, as shown in FIG. 7. The sarking method is merely one possible manner of installing a roof structure using the slip resistant sheet material 10 for roofing. For instance, the roof support structure 34 on which the slip resistant sheet material 10 for roofing is attached may include solid sheathing or spaced sheathing. Further, any type of batten structure may be attached to the slip resistant sheet material 10 for roofing for supporting the overlayment 36, such as wood battens, steel battens, plastic battens, counter-battens made from any of these materials, or the overlayment 36 may be attached directly to the roof support structure 34 through the slip resistant sheet material 10 for roofing.

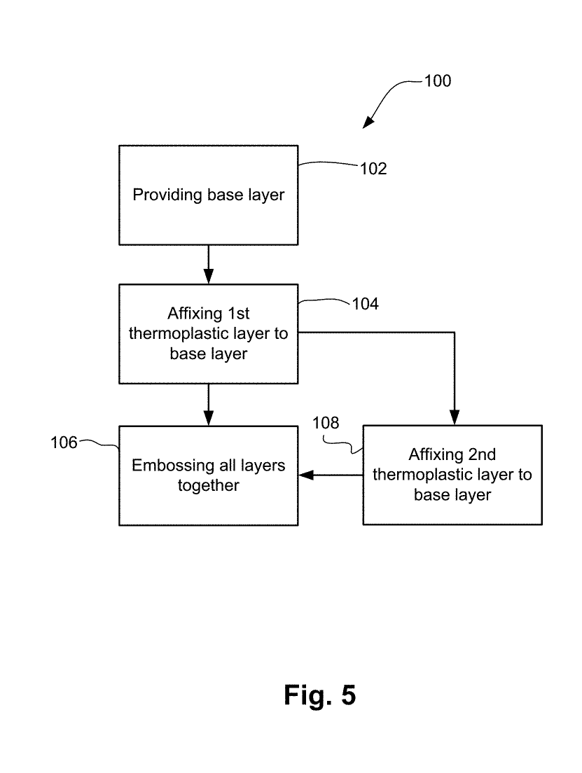

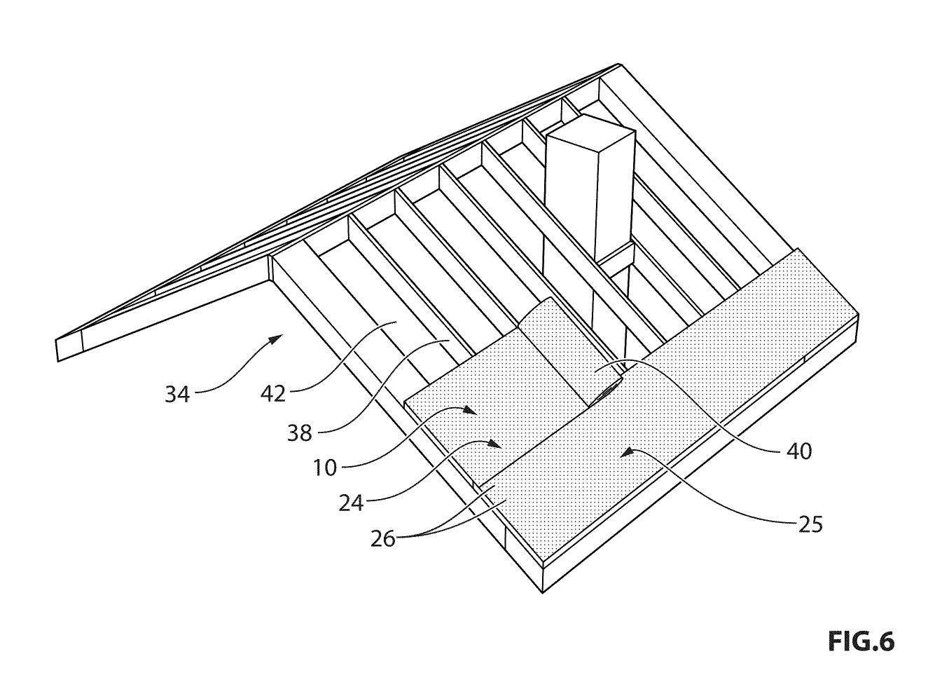

According to another embodiment and referring to FIG. 5, there is provided a method 100 for manufacturing a slip resistant sheet material 10 for roofing having an upper side and a lower side.

The method 100 comprises providing a closed-weave woven base layer having a top surface facing in a same direction as the upper side (step 102). The method 100 further comprises affixing a first thermoplastic layer to the top surface (step 104). After affixing first thermoplastic layer to the top surface, the next step is embossing the base layer and the first thermoplastic layer to form projections in the same direction as the upper side at corresponding locations in the base layer and the first thermoplastic layer (step 106) thereby providing slip resistance on the upper side.

According to an embodiment, the embossing (step 106) is performed at ambient temperature.

According to an embodiment, the embossing (step 106) comprises embossing the base layer and the first thermoplastic layer with an engraved roller.

According to an embodiment, the closed-weave woven base layer further comprises a bottom surface opposite the top surface and the method 100 further comprises affixing a second thermoplastic layer to the bottom surface (step 108).

According to an embodiment, the affixing the first thermoplastic layer and the second thermoplastic layer (steps 104 and 108) comprises respectively directly affixing the first thermoplastic layer and the second thermoplastic layer to the top surface and to the bottom surface without use of an adhesive or another intermediate layer.

According to an embodiment, the affixing the first thermoplastic layer and the second thermoplastic layer (steps 104 and 108) comprises respectively extruding a film-forming polymer (not shown) thereby producing the first thermoplastic layer and the second thermoplastic layer.

According to an embodiment, further comprising respectively bonding the first thermoplastic layer and the second thermoplastic layer to the top surface and to the bottom surface (not shown).

According to an embodiment, the extruding a film-forming polymer (not shown) comprises extruding at least one of: polyethylene and polypropylene.

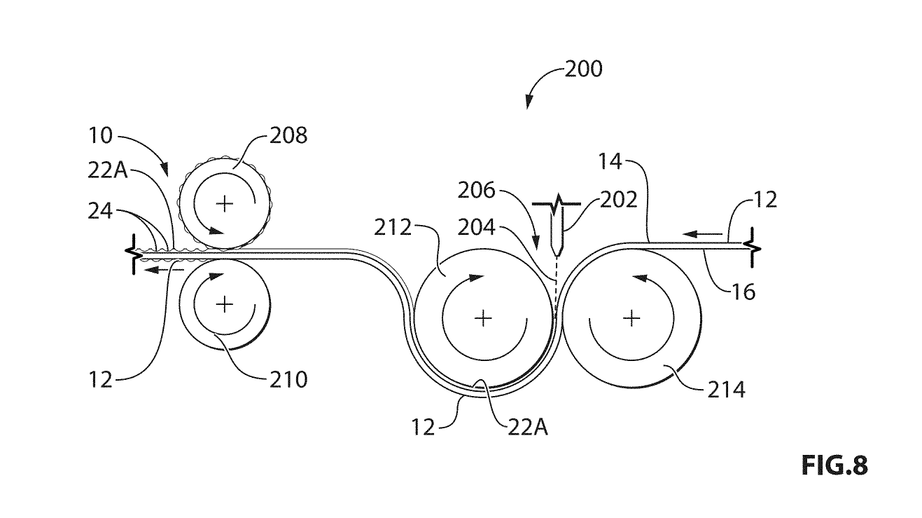

In accordance with another embodiment, there is provided a process 200 for manufacturing the slip resistant sheet material 10 for roofing. The process 200 for manufacturing the slip resistant sheet material 10 for roofing is shown in FIG. 8. First, the closed-weave woven base layer 12 is unwound into an unwinding machine for showing upwardly the top surface 14 of the closed-weave woven base layer 12. Next, a polymer film 204 is extruded through a heated die 202 to form a first thermoplastic layer 22A. The first thermoplastic layer 22A bonds to the top surface 14 of the closed-weave woven base layer 12 at the nip point 206 where at least one of rollers 212, 214 is cooled for cooling the temperature of the closed-weave woven base layer 12 which is being bonded with the first thermoplastic layer 22A. Optionally (not shown), the closed-weave woven base layer 12 is wounded and again unwound into the unwinding machine for showing upwardly the bottom surface 16 of the closed-weave woven base layer 12. Another polymer film 204 is then extruded through the heated die 202 to form the second plastic layer 22B covering the bottom surface 16 of the closed-weave woven base layer 12. The second thermoplastic layer 22B then bonds to the bottom surface 16 of the closed-weave woven base layer 12 at the nip point 206, where at least one of rollers 212, 214 is cooled for cooling the temperature of the closed-weave woven base layer 12 which is being bonded with the second thermoplastic layer 22B. Finally, at ambient temperature, the closed-weave woven base layer 12 that is now extruded with first and/or second thermoplastic layers 22A, 22B passes through an engraved roller 208 and a backer roller 210. Using this process 200, the embossed pattern 24 is respectively cast into the first thermoplastic layer 22A, the closed-weave woven base layer 12 and alternatively, the second thermoplastic layer 22B. Since the step of passing the closed-weave woven base layer 12 through the engraved roller 208 and the backer roller 210 is performed once the closed-weave woven base layer 12 is extruded with first and second thermoplastic layers 22A, 22B, there is no need for one or both roller(s) 212, 214 to be temperature controlled to cool the polymer film extrusion and engraved to provide the embossed pattern 24.

Alternatively, instead of passing between the engraved roller 208 engraved with bump patterns 216 and the backer roller 210, the closed-weave woven base layer 12 that is extruded with or sandwiched between the first and/or second thermoplastic layers 22A, 22B, may pass under a press plate engraved with bump patterns (not shown).

The engraved roller 208 is substantially cylindrical and includes a surface configured for embossing the slip resistant sheet material 10 to form the anti-skid surface. The surface of the engraved roller 208 includes a texture formed by a plurality of features that are raised and or sunken with respect to remainder of the surface of the engraved roller 208. For example, the surface can include a plurality of protrusions from the surface of the engraved roller, a plurality of depressions in the surface of the engraved roller or both. The texture for forming the embossment on the closed-weave woven base layer 12 and on the thermoplastic layer(s) 22A and/or 22B may be of varying heights or depths or can be substantially the same height or depth. Example of heights and depths of the texture include between 0.01 mm to 10 mm. The texture can be disposed on the surface of the engraved roller 208 randomly or can be configured as a uniform or repeated pattern. Where the texture is disposed as an array of uniform or repeating configurations, examples may include straight lines, a cross-hatch pattern, a chevron pattern, a checked pattern, a company logo, dots, and the like. The texture can include raised and/or sunken features that are adjacent to each other or spaced apart from each other providing various densities. Examples include where the texture includes between 1 feature and 100 features per cm² of the surface of the engraved roller 208. Additionally, the features of the texture can have the same shape or can have varying shapes such as square, triangular, circular, ovular, obround, rectangular, random, or any other suitable shape configured to form the anti-skid surface.

Various additives may be included or applied to the slip resistant sheet material 10. Examples may include various colorants, heat stabilizers, waterproofing treatments, strengthening laminates, antimicrobials, UV blockers and light stabilizers. The slip resistant sheet material 10 may also be printed with signage, such as logos, installation instructions, and/or orientation indicia.

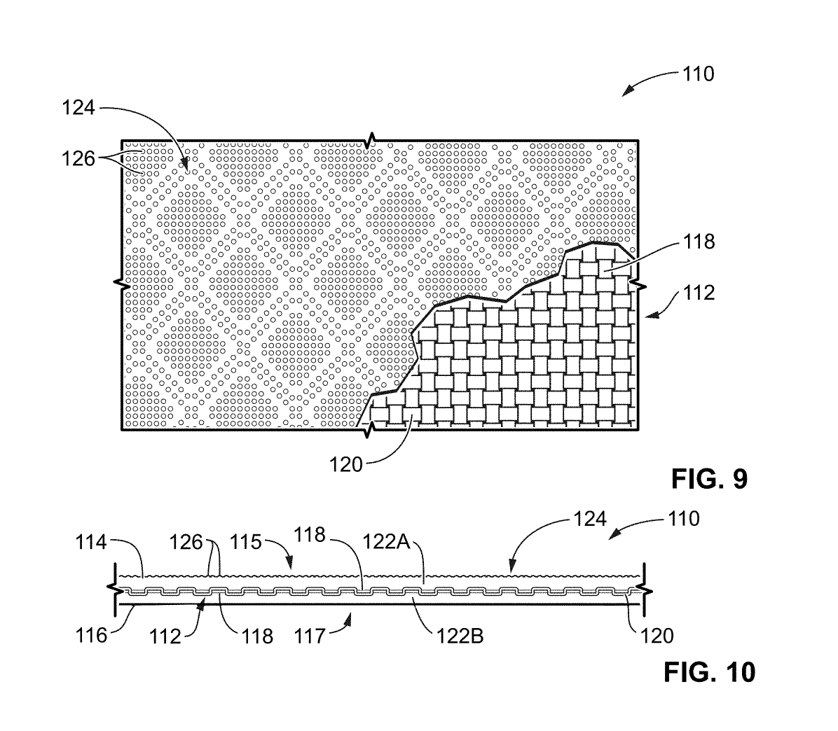

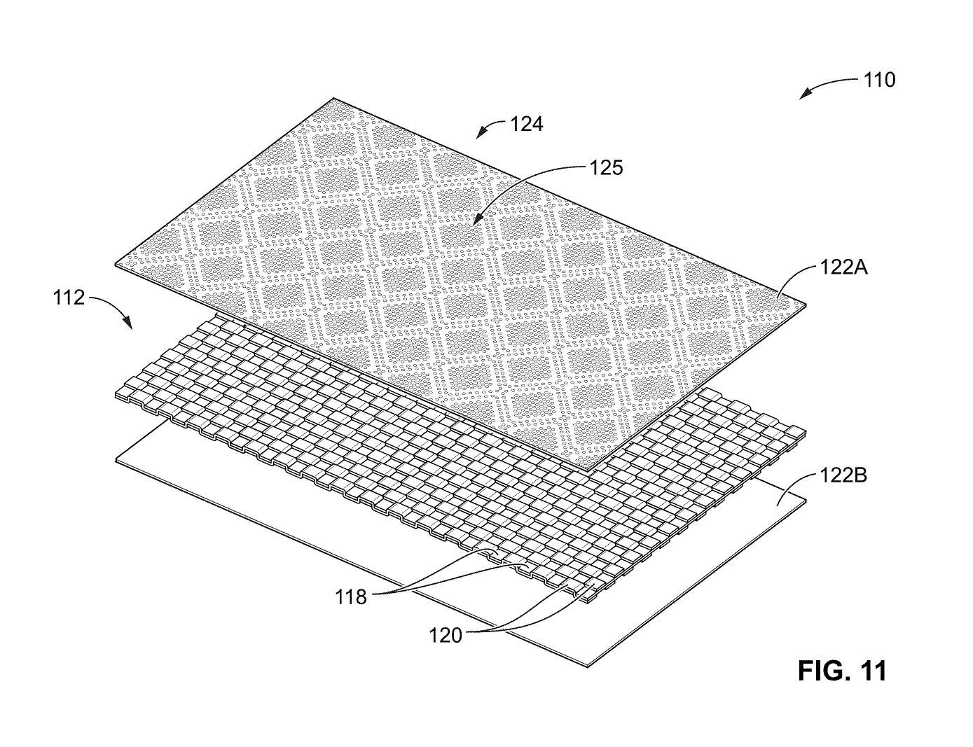

According to another embodiment in relation with particularly FIGS. 9 to 19, there is shown another slip resistant sheet material 110 for roofing. The slip resistant sheet material 110 for roofing has an upper side 115 and a lower side 117. The slip resistant sheet material 110 for roofing further includes a base layer 112 which defines a top surface 114 and a bottom surface 116 (FIG. 10). The top surface 114 faces in a same direction as the upper side 115.

According to an embodiment, base layer 112 comprises a closed-weave woven which is referred herein to as a closed-weave woven base layer 112. According to another embodiment, the base layer 112 comprises a non-woven fibrous material such as a spunbond polyester substrate.

According to an embodiment, the closed-weave woven base layer 112 comprises yarns of a first direction 118 and yarns of a second direction 120 and is manufactured in a similar fashion as base layer 12. Accordingly, the slip resistant sheet material 110 for roofing comprises a first thermoplastic layer 122A and (according to another embodiment) additionally a second thermoplastic layer 122B respectively affixed to the top surface 114 and the bottom surface 116 of the closed-weave woven base layer 112 for providing a weather-resistant barrier

As shown in FIGS. 9-11, the first thermoplastic layer 122A is embossed to form an embossed pattern 124 comprising embossments 126.

One must note that the terms “embossing”, “embossment”, “embossed” material and the result from a process of embossing are intended to refer to the result of an impression produced by pressure or printing and the process of making that impression over a receiving material or surface.

The embossed pattern 124 comprises a plurality of embossments 126 or define reliefs that outwardly extend from the first thermoplastic layer 122A for providing slip resistance on the upper side 115. The embossments 126 of the embossed pattern 124 in the first thermoplastic layer 122A provide an anti-skid surface/enhanced friction surface/slip resistant surface.

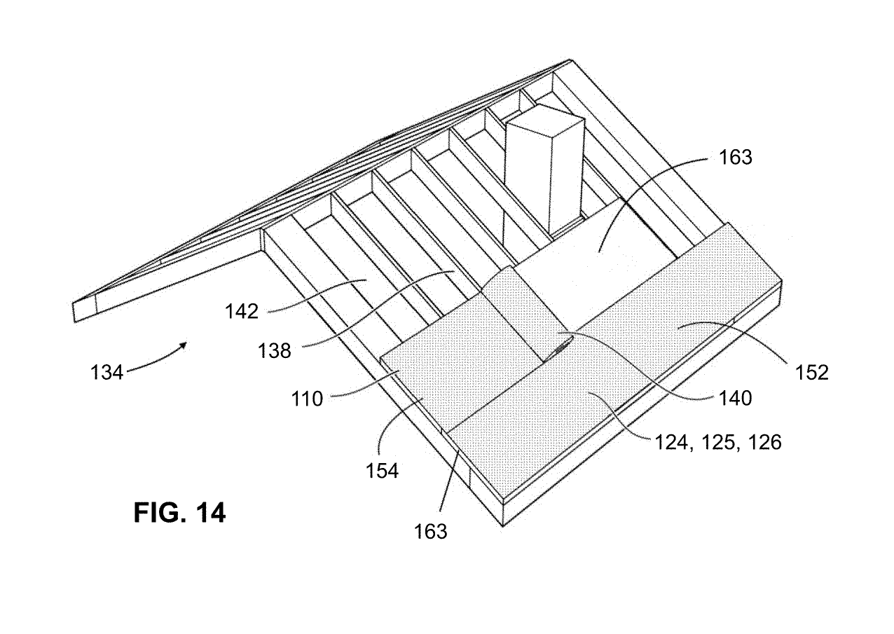

The embossed pattern 124 increases the slip resistance and thereby increases safety of those walking on roofs on which the slip resistant sheet material 110 is installed before installation of an overlayment 136 (FIGS. 13-16).

The embossed pattern 124 comprise embossments 126 spread, scattered, dispersed or punctuated over the upper side 115 providing through the inter-embossment depressions paths for rain falling on the upper side 115 for the rain to flow downward between the embossments 126 when the slip resistant sheet material 110 is installed on a sloped structure, leaving the embossments 126 free of water and thereby enhancing friction surface. Furthermore, the embossed pattern 124 comprise embossments 126 spread, scattered, dispersed or punctuated at an embossment density insuring the footstep of those walking on roofs on which the slip resistant sheet material 110 is installed to always step over a plurality of embossments 126.

According to FIGS. 9-11, there is shown that the embossments 126 are regularly spaced within the embossed pattern 124 such as to define a specific mosaic or pattern, such as pattern 125. However, it is to be noted that the embossments 126 may be irregularly spaced within the embossed pattern 124 as long as it is designed to increase the slip resistance and thereby increases safety of those walking on roofs on which the slip resistant sheet material 10 is installed before installation of the overlayment 136.

According to FIGS. 9-11, there is shown that the plurality of embossments 126 are dimensioned, in size and height, as a preferred proportion of the whole thickness of the slip resistant sheet material 110. However, it is to be noted that in alternative embodiments the plurality of embossments 126 are differently dimensioned, the selected alternative dimensions being based in part on the thickness of the first thermoplastic layer 122A. In further alternative embodiments, the dimensions of the embossments 125 of a same slip resistant sheet material 110 vary in size and/or in height. According to embodiments, the height of the embossments is selected between 580RA and 620RA of the first thermoplastic layer 122A, where RA is a measure of surface roughness (https://en.wikipedia.org/wiki/Surface_roughness).

The embossed pattern 124 includes a texture formed by a plurality of features that are raised and or sunken with respect to the first thermoplastic layer 122A. For example, the texture can include a plurality of protrusions, embossments or projections 126 in the first thermoplastic layer 122A. The texture of the embossed pattern 124 may be of varying heights or depths or can be substantially the same height or depth. Example of heights and depths of the texture include between about 0.01 mm to 10 mm. The texture can be disposed randomly or can be configured as a uniform or repeated pattern, such as pattern 125. When the texture is disposed as an array of uniform or repeating configurations, examples may include straight lines, a cross-hatch pattern, a chevron pattern, a checked pattern, a company logo, dots, and the like. The texture can include raised and/or sunken features that are adjacent to each other or spaced apart from each other providing various densities. Examples include where the texture includes between 1 feature to 100 features per cm² of the slip resistant sheet material 110. Additionally, the features of the texture can have the same shape or can have varying shapes such as square, triangular, circular, ovular, obround, rectangular, random, or any other suitable shape configured to form the anti-skid surface.

According to an embodiment, the shape(s) is (are) selected based on enhanced friction characteristics and water flow characteristics.

In accordance with embodiments, the slip resistant sheet material 110 may include only one thermoplastic layer, a first and a second thermoplastic layers, or a plurality of different thermoplastic layers, some providing weather-resistant barrier, some other providing UltraViolet (UV)-resistant barrier, microbial properties, heat resistant properties and the like. This configuration will provide the characteristics sought-after for durability requirements and by those walking on roofs.

In accordance with an embodiment, the thermoplastic layer or the plurality of thermoplastic layers 122A, 122B may include a film-forming polymer.

In accordance with an embodiment, the thermoplastic layer or the plurality of thermoplastic layers 122A, 122B comprise(s) polyethylene, polypropylene or a mixture of polyethylene and polypropylene.

The slip resistant sheet material 110 for roofing is shown as having a thermoplastic layer 122A or 122B positioned over each side of the closed-weave woven base layer 112. However, it is understood that certain applications may allow the closed-weave woven base layer 112 to have only its upper side 115 coated with a thermoplastic layer. The thermoplastic layer(s) (such as first and second thermoplastic layers 122A, 122B) may include polyethylene, polypropylene, or other similar thermoplastic polymers.

The slip resistant sheet material 110 for roofing is formed by extruding at least one layer of thermoplastic polymer over the closed-weave woven base layer 112. According to embodiments, the first or the first and second thermoplastic layers 122A, 122B are directly affixed to the base layer without use of an adhesive or another intermediate layer.

According to another embodiment, the thermoplastic layer, or at least one thermoplastic layer may be affixed to the closed-weave woven base layer 112 using an adhesive or any other manner of attachment.

The thermoplastic layers (i.e., such as first and second thermoplastic layers 122A, 122B) may be variably pigmented to allow the color of the thermoplastic layers to be selected based upon particular requirements. The thickness of the thermoplastic layers is selected such that the slip resistant sheet material 110 for roofing is flexible, whereby the flexible nature of the slip resistant sheet material 110 for roofing allows it to be formed into rolls and easily installed by simply unrolling the slip resistant sheet material 110 for roofing over a roof support structure or the like.

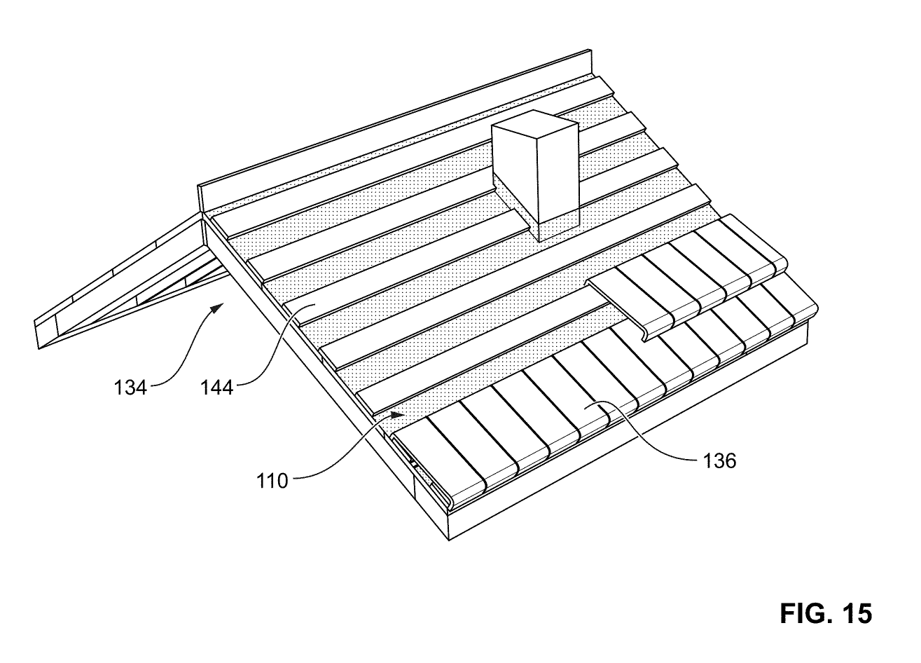

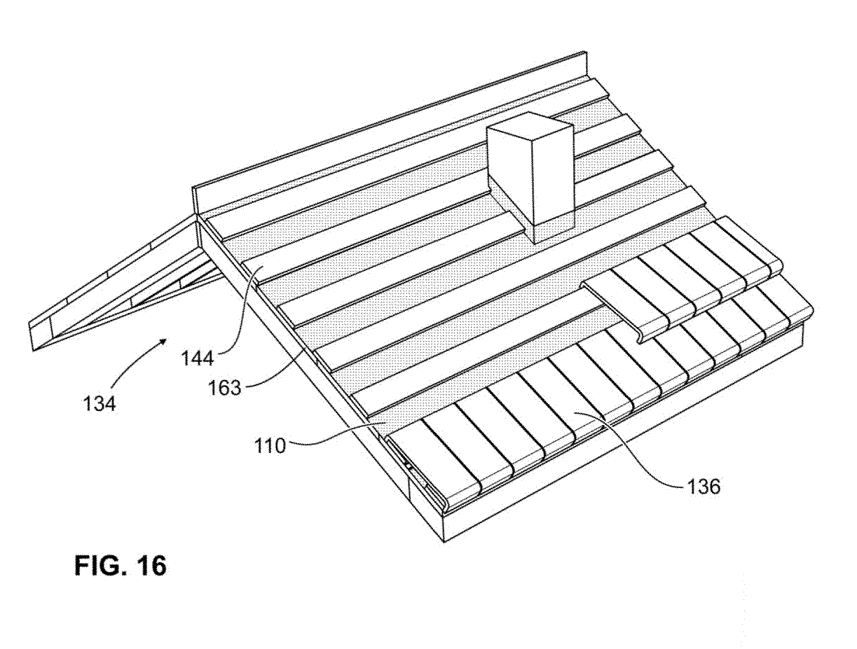

The slip resistant sheet material 110 for roofing may be installed between a roof support structure 134 (FIGS. 13, 14) and an overlayment 136 (FIGS. 15, 16) in order to provide a waterproof barrier for the roof structure. The slip resistant sheet material 110 for roofing may be mechanically fastened to the roof rafters 138 (FIG. 13) or to the panels 163 (a.k.a. paneling, e.g. plywood, presswood, etc.) (FIG. 14) using nails or screws, but it is understood that the slip resistant sheet material 10 for roofing may be affixed to the roof rafters 138 or to the panels 163 using adhesives or other possible attachment methods.

According to an embodiment, the rolls 140 are of a length allowing the whole width of the roof to be covered with the sheet material 110 for roofing without any interruption lengthwise. According strips of the slip resistant sheet material 110 for roofing are installed bottom up, a bottom edge portion of the top strip 154 of slip resistant sheet material 110 for roofing covering a top edge portion of the bottom strip 152.

The slip resistant sheet material 110 for roofing may be formed from a plurality of thermoplastic layers having an improved resistance to deterioration from exposure to external elements, such as moisture and dirt, so that the slip resistant sheet material 110 for roofing has an improved durability and longevity. Moreover, employing closed-weave woven base layer 112 including yarns of a second gauge 132 in the slip resistant sheet material 110 for roofing provides an improved tensile strength capable of being walked upon without tearing when being installed on the roof. The closed-weave woven base layer 112 further provides improved strength to resist tearing when exposed to external forces, such as collected moisture, wind, and other external forces.

As shown, the improved resistance to deterioration and tearing provided by the slip resistant sheet material 110 for roofing improves the integrity and effectiveness of the weather-resistant barrier provided by the slip resistant sheet material 110 for roofing. By improving the longevity of the waterproof integrity of the slip resistant sheet material 110 for roofing to more closely match the integrity of the entire roof structure, the longevity of the integrity of the entire roof structure is improved.

According to an embodiment, and referring now to FIGS. 13-16, there is shown a perspective view of the slip resistant sheet material 110 for roofing being installed on an exemplary roof structure. The slip resistant sheet material 110 for roofing is to be installed between a roof support structure 134 and an overlayment 136 in order to provide a waterproof barrier and a slip resistant material for the roof structure. As shown, the slip resistant sheet material 110 for roofing may be formed into rolls 140 which can be simply unrolled over the roof support structure 134 to allow for easy installation. In this exemplary roof structure, a method is utilized where the slip resistant sheet material 110 for roofing is fastened to the top side of the panels 163. According to another exemplary roof structure (not shown), a sarking method is utilized where the slip resistant sheet material 110 for roofing is fastened to the top side of the roof rafters 138, thus allowed to drape between the open rafter bays 142. The slip resistant sheet material 110 for roofing is preferably mechanically fastened to the roof rafters 138 using nails or screws, but it is understood that the slip resistant sheet material 110 for roofing may be affixed to the roof rafters 138 using other adhesives or other possible attachment methods.

Battens 144 are then fastened over the slip resistant sheet material 110 for roofing and into the top side of the roof rafters 138, where the overlayment 136 is then attached to the battens 144, as shown in FIGS. 13 and 15.

The sarking method is merely one possible manner of installing a roof structure using the slip resistant sheet material 110 for roofing. For instance, the roof support structure 134 on which the slip resistant sheet material 110 for roofing is attached may include solid sheathing or spaced sheathing. Further, any type of batten structure may be attached to the slip resistant sheet material 110 for roofing for supporting the overlayment 136, such as wood battens, steel battens, plastic battens, counter-battens made from any of these materials, or the overlayment 136 may be attached directly to the roof support structure 134 through the slip resistant sheet material 110 for roofing.

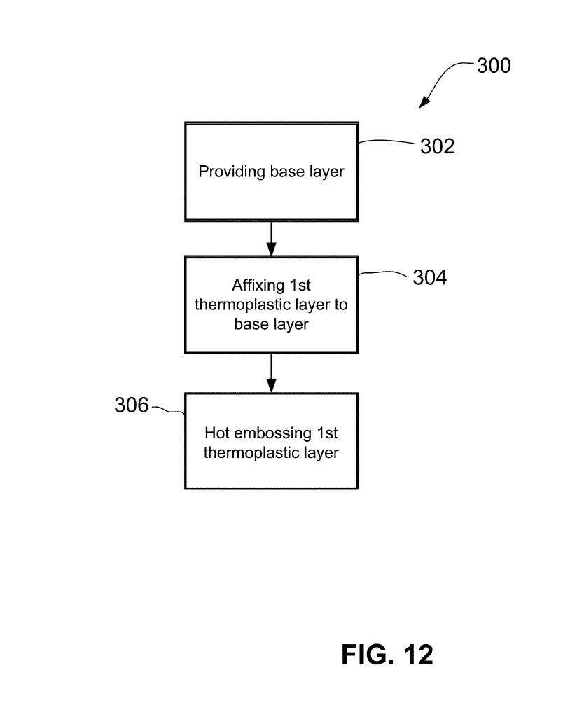

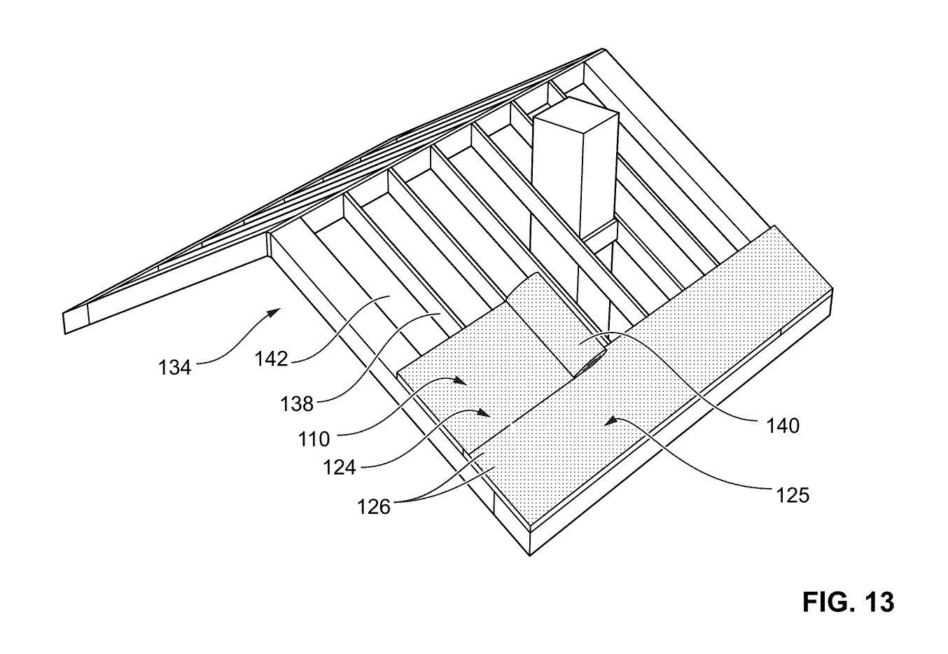

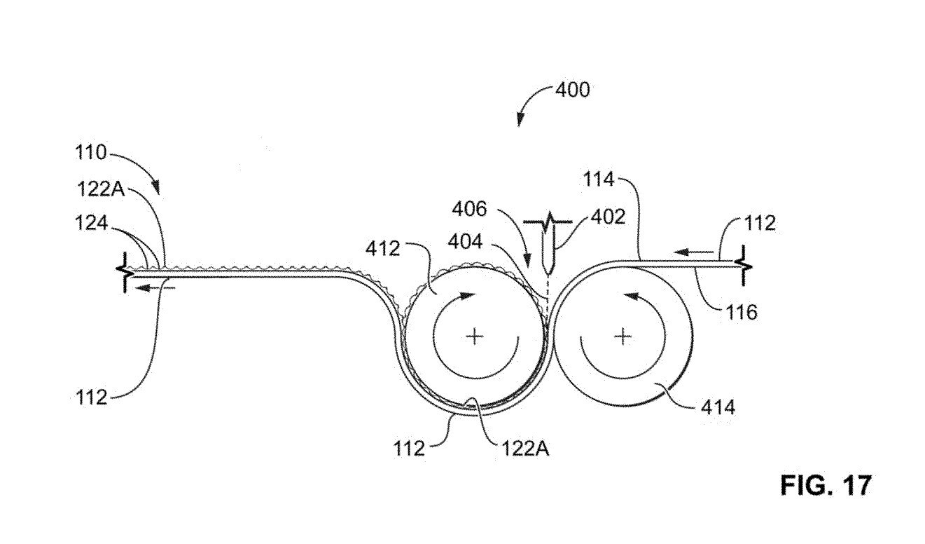

According to another embodiment and referring to FIGS. 12 and 17, there is provided a method 300 for manufacturing a slip resistant sheet material 110 for roofing having an upper side and a lower side.

The method 300 comprises providing a closed-weave woven base layer 112 having a top surface 114 facing in a same direction as the upper side (step 302).

The method 300 further comprises extruding a polymer film 404, forming a curtain of polymer film 404, through a heated die 402 to form a first thermoplastic layer 122A to the top surface 114 (step 304).

The next step comprises embossing the first thermoplastic layer 122A to form embossments in the first thermoplastic layer 122A in its top surface 114 (step 306) thereby providing slip resistance on the upper side.

According to an embodiment, the embossing (step 306) is performed at a temperature allowing the first thermoplastic layer 122A to be easily shaped while having the deformations, namely the embossments, remaining permanently imprinted in the first thermoplastic layer 122A when the first thermoplastic layer 122A is cooling down.

According to an embodiment, the embossing temperature is between about 550F to 600F allowing the molten polymer to be formed and set by the textured pattern.

According to an embodiment, the embossing (step 306) comprises embossing the first thermoplastic layer with engraved means, and according to this embodiment an engraved roller 412.

According to an embodiment, the embossing (step 306) comprises compelling movement to the slip resistant sheet material on the side opposite the first thermoplastic layer 122A with a plain roller 414.

According to an embodiment, the affixing the first thermoplastic layer 122A (step 304) and optionally affixing the second thermoplastic layer 122B (step not shown) comprises respectively directly affixing the first thermoplastic layer 122A and optionally the second thermoplastic layer 122B to the top surface 114 and to the bottom surface 116 without use of an adhesive or another intermediate layer.

According to an embodiment, the affixing the first thermoplastic layer 122A (step 304) and optionally the second thermoplastic layer 122B (step not shown) comprises respectively extruding a film-forming polymer thereby producing the first thermoplastic layer and optionally the second thermoplastic layer.

According to an embodiment, further comprising respectively bonding the first thermoplastic layer 122A and optionally the second thermoplastic layer 122B to the top surface 114 and to the bottom surface 116 (not shown).

According to an embodiment, the extruding a film-forming polymer comprises extruding at least one of: polyethylene and polypropylene.

In accordance with another embodiment, there is provided a process 400 for manufacturing the slip resistant sheet material 110 for roofing. The process 400 for manufacturing the slip resistant sheet material 110 for roofing is more specifically shown in FIG. 17. First, the closed-weave woven base layer 112 is unwound into an unwinding machine and exposes upwardly the top surface 114 of the closed-weave woven base layer 112. Next, a polymer film 404 is extruded through a heated die 402 to form a first thermoplastic layer 122A. The first thermoplastic layer 122A bonds to the top surface 114 of the closed-weave woven base layer 112 at the nip point 406 where at least one of rollers 412, 414 is cooled for cooling the temperature of the closed-weave woven base layer 112 which is being bonded with the first thermoplastic layer 122A. Furthermore, at this step, the embossing roller 412 embosses permanently the hot first thermoplastic layer 122A. Optionally (not shown), afterwards the closed-weave woven base layer 112 is wounded and again unwound into the unwinding machine for showing upwardly the bottom surface 116 of the closed-weave woven base layer 112. Another polymer film 404 is then extruded through the heated die 402 to form the second thermoplastic layer 122B covering the bottom surface 116 of the closed-weave woven base layer 112. The second thermoplastic layer 122B then bonds to the bottom surface 116 of the closed-weave woven base layer 112 at the nip point 406, where at least one of rollers 412, 414 is cooled for cooling the temperature of the closed-weave woven base layer 112 which is being bonded with the second thermoplastic layer 122B. It must be noted that this step of affixing the second thermoplastic layer 122B may use the same rollers 412, 414 or a set of different rollers based on the desire or not to obtain the embossing on the bottom surface 116. Finally, the slip resistant sheet material 110 is cooled down and formed into rolls 140 for storage.

The embossing roller 412 is substantially cylindrical and includes a surface configured for embossing the slip resistant sheet material 110 to form the anti-skid surface. For example, the surface can include a plurality of protrusions from the surface of the embossing roller 412, a plurality of depressions in the surface of the engraved roller 412 or both. The texture for forming the embossment on the closed-weave woven base layer 112 and on the thermoplastic layer(s) 122A and/or 122B may be of varying heights or depths or can be substantially the same height or depth. Example of heights and depths of the texture include between 0.01 mm to 10 mm. The texture can be disposed on the surface of the embossing roller 412 randomly or can be configured as a uniform or repeated pattern. Where the texture is disposed as an array of uniform or repeating configurations, examples may include straight lines, a cross-hatch pattern, a chevron pattern, a checked pattern, a company logo, dots, and the like. The texture can include raised and/or sunken features that are adjacent to each other or spaced apart from each other providing various densities. Examples include where the texture includes between 1 feature and 100 features per cm² of the surface of the embossing roller 412. Additionally, the features of the texture can have the same shape or can have varying shapes such as square, triangular, circular, ovular, obround, rectangular, random, or any other suitable shape configured to form the anti-skid surface.

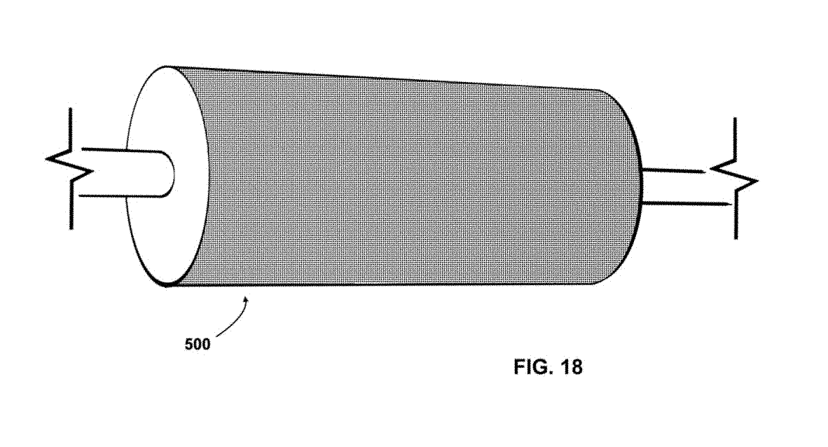

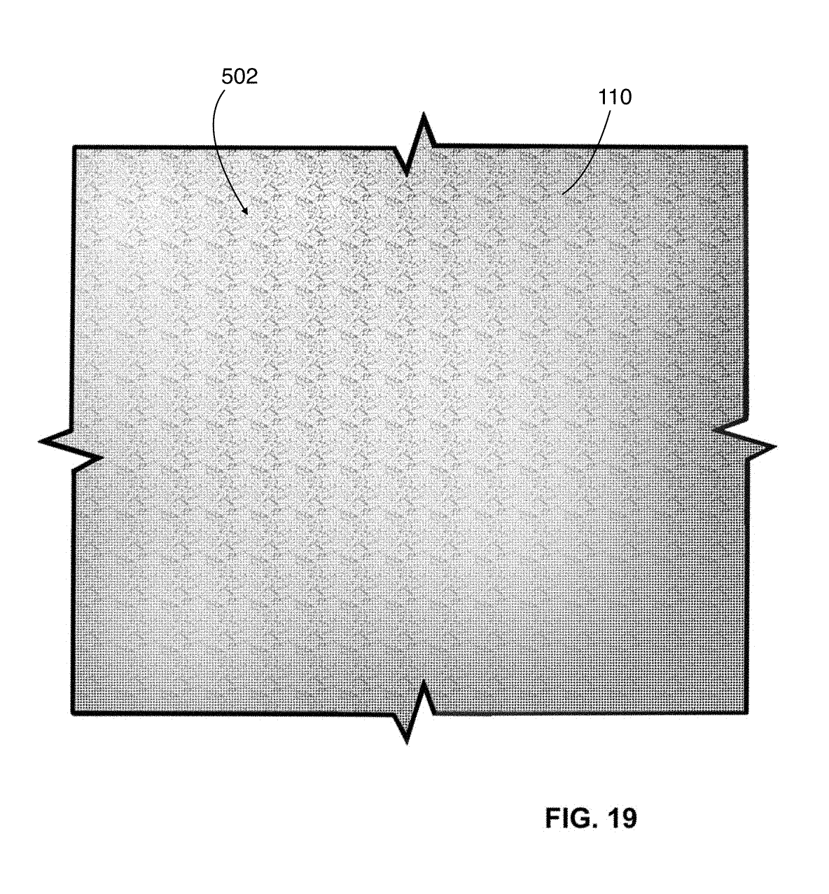

According to an embodiment illustrated through FIGS. 18 and 19, a roller 500 having a substantially porous surface is used to manufacture the slip resistant sheet material 110 for roofing. The manufactured slip resistant sheet material 110 for roofing therefore have a sandpaper-like texture 502 comprising a random pattern of small reliefs providing the slip-resistant characteristics.

Various additives may be included or applied to the slip resistant sheet material 110. Examples may include various colorants, heat stabilizers, waterproofing treatments, strengthening laminates, antimicrobials, UV blockers and light stabilizers. The slip resistant sheet material 110 may also be printed with signage, such as logos, installation instructions, and/or orientation indicia. Such a printing process would normally take place after the embossing process and before the process of forming the slip resistant sheet material 110 into rolls 140.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A slip resistant sheet material for roofing having an upper side, the slip resistant sheet material comprising:
a closed-weave woven base layer having a top surface facing towards the upper side; and
a thermoplastic layer affixed to the top surface, wherein the thermoplastic layer comprises, on the upper side, slip-resistant embossments and further wherein the slip-resistant embossments are present in the thermoplastic layer and absent from the closed-weave woven base layer.

2. The slip resistant sheet material of claim 1, wherein the thermoplastic layer has a thickness and wherein the embossments are defined transversely to the thickness of the slip resistant sheet material.

3. The slip resistant sheet material of claim 2, wherein the embossments have a height smaller than the thickness of the thermoplastic layer.

4. The slip resistant sheet material of claim 2, wherein the embossments are spread, scattered, dispersed or punctuated over the upper side.

5. The slip resistant sheet material of claim 2, further comprising inter-embossment depressions, wherein the inter-embossment depressions define paths for rain falling on the upper side to flow downward between the embossments when the slip resistant sheet material is installed on a sloped structure.

6. The slip resistant sheet material of claim 1, wherein the slip resistant sheet material is adapted for a worker to walk thereon in his footwear and whereby, when the worker walks or stands on the slip resistant sheet material, there exists friction between the footwear and the embossments on the thermoplastic layer thereby providing slip resistance.

7. The slip resistant sheet material of claim 1, wherein the closed-weave woven base layer further comprises a bottom surface opposite the top surface and the slip resistant sheet material further comprises an additional thermoplastic layer affixed to the bottom surface.

8. The slip resistant sheet material of claim 7, wherein at least one of the thermoplastic layer and the additional thermoplastic layer is directly affixed to one of the top surface and the bottom surface without use of an adhesive or another intermediate layer.

9. The slip resistant sheet material of claim 7, wherein at least one of the thermoplastic layer and the additional thermoplastic layer is vapor impermeable.

10. The slip resistant sheet material of claim 7, wherein at least one the thermoplastic layer and the additional thermoplastic layer is a film-forming polymer.

11. The slip resistant sheet material of claim 7, wherein at least one the thermoplastic layer and the additional thermoplastic layer comprises at least one of: polyethylene and polypropylene.

12. The slip resistant sheet material of claim 1, wherein the closed-weave woven comprises cross-laminated polyethylene tape.

13. A method of manufacturing a slip resistant sheet material for roofing having an upper side, the method comprising the steps of:
providing a closed-weave woven base layer having a top surface;
affixing a thermoplastic layer to the top surface of the closed-weave woven base layer; and
embossing the thermoplastic layer with an embossed roller comprising a pattern of depressions, the embossing transferring the pattern of depressions to the upper side of the slip resistant sheet material into a pattern of slip-resistant embossments, wherein the slip-resistant embossments are present on the thermoplastic layer and absent from the closed-weave woven base layer.

14. The method of claim 13, wherein the embossing step is performed before cooling down the thermoplastic layer.

15. The method of claim 13, wherein the embossing step comprises passing the slip resistant sheet material between two rollers, wherein one of the two rollers comprises the embossing roller.

16. The method of claim 13, wherein the closed-weave woven base layer further comprises a bottom surface opposite the top surface and the method further comprises affixing an additional thermoplastic layer to the bottom surface.

17. The method of claim 16, wherein at least one of the affixing the thermoplastic layer step and the affixing the additional thermoplastic layer step comprises directly affixing the respective one of the thermoplastic layer and the additional thermoplastic layer to the respective one of the top surface and to the bottom surface without use of an adhesive or another intermediate layer.

18. The method of claim 16, wherein at least one of the affixing the thermoplastic layer step and the affixing the additional thermoplastic layer step comprises respectively extruding a film-forming polymer thereby producing the thermoplastic layer and the additional thermoplastic layer.

19. The method of claim 18, wherein the extruding a film-forming polymer step comprises extruding at least one of: polyethylene and polypropylene.
